(19) United States
(12) Patent Application Publication
(10) Pub. No.: US 2002/0004763 A1
(43) Pub. Date: Jan. 10, 2002

(54) Body profile coding method and apparatus useful for assisting users to select wearing apparel

(76) Inventor: Peter Ar-Fu Lam, Torrance, CA (US)

Correspondence Address: Peter Ar-Fu Lam, 20104 Wayne Ave., Torrance, CA, 90503, US

(21) Appl. No.: 09/930,422

(22) Filed: Aug. 15, 2001

Related U.S. Application Data
(63) Continuation-in-part of application No. 09/685,311, filed on Oct. 10, 2000.
(63) Continuation-in-part of application No. PCT/US01/01923, filed on Jan. 19, 2001.
(60) Provisional application No. 60/177,404, filed on Jan. 20, 2000.
(60) Provisional application No. 60/180,108, filed on Feb. 3, 2000.

(51) Int. Cl. G06F 17/60

(52) U.S. Cl. 705/26

(57) ABSTRACT

A computer supported system especially configured for users to easily coordinate or harmonize apparel before making a purchasing decision. The embodiments include a body profile generating, encoding and decoding system. The system provides the conversion of a body profile code to fit with a particular garment size defined by a garment size chart. The enhanced body profile coding and decoding system also provide flexibility and room for future expansion and applications.

This is the Continuation In Part of applicant's pending patent application Ser. No. 09/685311; PCT/US01/01923; and provisional applications 60/177404 and 60/180108.

### FIELD OF THE INVENTION

This invention relates generally to methods and apparatus for use by retailers for facilitating a customer's selection of coordinated and properly sized articles of wearing apparel.

### BACKGROUND OF THE INVENTION

Various systems have been discussed in the prior art for assisting a user to select coordinated and properly sized articles of wearing apparel; e.g. U.S. Pat. Nos. 4,149,246; 4,539,585; 5,163,007; 5,515,248; 5,680,528; 5,724,522; 5,850,222; 5,930,769; 5,937,081; 5,970,471 and 5,974,400.

Applicant's priority applications describe the use of a monitor for electronically displaying a facial image in combination with a garment supporting structure which can be used as follows:

(1) Provide a facial image capture set up at a point of sale.

(2) Facial images of customers are collected with this setup.

(3) The facial image is digitized into electronics data and stored as a file.

(4) A code word or file name is assigned to each file to identify the facial image of one customer from another.

(5) The file is decoded and displayed on the computer monitor mounted on top of the garment displaying stand.

(6) Input device such as key pad, joystick, mouse or other point device and even voice recognition device are used to identify which facial image is to be displayed and also to provide adjustment, options selection and modification of the facial image or the relative position of the image to be displayed.

With greater investment in storage memory and image playback facilities, multiple facial images from different viewing angles can be collected. In this situation, the display stand can be rotated for viewing the garment in different orientations, when the orientation of the facial image is changed. If multiple facial images are collected at a high frame rate such as 25 frames per second while the viewing angle is continuously changing, the playback of the facial image at the monitor will provide a movie like movement result. To fully match with the movie play back effect, such as when the user's head is turning left or right, the garment is moved in the same direction and in synchronization with the head turning motion displayed. The overall result becomes an animated presentation of the garment coordination matching with the user.

Once a customer registers his/her facial image at an image capturing facility, the image file, identified by a code word, can be sent to a remote computer by a communication channel. A communication link (or communication channel) refer to any means connecting two computing devices together, including internet, intranet, extranet, ISDN, DSL, LAN and any future connection systems. The communication channel can be provided by wired lines such as cable, optical lines or telephone lines. It can be connected to the computer by any commercially available format of communication such as COM port, parallel port, Firewire and USB port. In addition to connected wires, the communication channel can be furnished by wireless channel such as RF and infra red channels as well. An example of RF link is represented by the recently established Bluetooth standard. A fashion store may also set up a library of images representing its garment collection at the remote computer. Garment images can be created by the same process to capture the electronics image file of a facial image; partially or completely created by image drafting software commercially available. With this service, customers may access the web site of the fashion store from the internet or the world wide web to fetch the file representing their facial images and/or the images of the garment to be selected. With the support of proper software, the facial image of the customer and the garment can be combined and displayed on the computer monitor located at the home of the potential customer. Personalized animated fashion show is also possible if multiple facial images and the garment are provided. This service gives customers greater confidence before they placed mail orders and avoids returns. Alternatively, customers may preview their preferred garment, and coordinated with their facial images. After customers record their preference, they may place a mail order. Alternatively customers may go to a store to actually try their short listed preferences and then confirm their purchase.

Applicant's pending PCT application number PCT/US01/01923 also revealed the concept of using a mathematical algorithm to compress the body measurements of a human and/or garment body into a body profile code (BP code).

### SUMMARY OF THE INVENTION

The present invention is directed to an enhanced system for facilitating traditional and/or internet retail sales of garments, i.e., wearing apparel. A business method in accordance with the invention for use by clothing retailers includes:

acquiring a customer body profile (BP) code defining multiple values respectively describing different physical dimensions of a customer's body;

providing a plurality of garment body profile (BP) codes each representing a different garment, each garment BP code defining multiple values respectively describing different physical dimensions of a garment;

processing said customer BP code and a selected garment BP code to identify dimensional differences between said customer's body and the garment represented by said selected garment BP code; and

producing human understandable output indicating the dimensional differences between said customer's body and said garment related to said selected garment BP code.

More particularly, the present invention is directed to a full service system to automate capturing data about the body profile (BP) parameters of a user (or customer), and assigning a personalized ID number to this data file. Other personalized data that can be applied into the system is a pass word enabling a computing apparatus to fetch a personalized data file upon request. Another important part of the system is to provide garment images, in the way that the shape and size of the garment image will be adjusted to match the body profile of the user; bigger garment for bigger people and thinner garment for skinny people. Together with a facial image of the user, appropriately combined with the garment image, a virtual garment coordination system is provided allowing the user to efficiently appraise the real life coordination with different garments without actually putting on the garments one by one. When the user profile data base and garment data base are configured to provide animated images, a personalized fashion show is then possible. Besides, the computer supported garment coordination system enables the coordination images of two different garments to be placed side by side on a same display screen for instant comparison purpose.

Once a user identifies a preferred garment, the data file describing the body profile of the user can be used to match with the sizes of available garment inventory. If a stocked item fitting the body profile of the user is available, the sale can be concluded. If a matching item is not available, the user will be notified and a rain check can be generated. Alternatively, a work order can be generated for the factory to manufacture the selected garment perfectly fitting the size of the user. On the manufacturing side, the BP coding system described hereinafter can be linked up with a CAM (computer aided manufacturing) facility. Further automation is possible by making use of the BP code to automatically plan and/or cut the fabric according to the design pattern of the garment selected.

In accordance with a preferred embodiment, a camera is set up in front of a user to capture images of the user. The images of the user including the facial image and the body image are converted into digital data. A computer assisted apparatus such as a DSP (digital signal processor) is then provided to analyze the body images of the user and generate several dimensional parameters characterizing the dimensional requirements of a garment to fit the body size of the user. Such parameters may include, but are not limited to shoulder width, arm length, neck circumference, upper torso height, waist dimension, inseam dimension, hips size and waist to ground level.

In order for the video data describing the body parameters of a person to be distinguishable from the background of a picture captured by the camera, a non-interfering background is provided. In accordance with a traditional chroma keying effect being used in TV recording studios, the background picture is a blue wall or a picture mainly decorated with blue tones. Another technology capable of separating a human body from a background well know to the art is to take picture of a moving person while the background is stationary. The frozen snap shot of a moving body is then distinguishable from the stationary background. There are various other computer supported topological technologies well known to the art are capable to provide the desirable function of the invention.

Many DSP algorithms are capable of recognizing the human body profile. If a lower cost and less powerful visual measurement system is desired, a specially designed “measurement outfit” or “reference clothing” is recommended to provide higher accuracy result. The reference clothing is preferably to be of homogeneous color distinguishable from the background. It is preferably made of elastic material such as spandex for two reasons: (1) for the reference clothing to fit people of different weights; and (2) for the body curvature of the user body to be fully visible by the imaging system. A reference mark of design and color significantly distinguishable to computer vision is also recommended to help locating the critical reference points of the human body, such as the neck, the shoulder, the wrist, the waist and the ankle. An alternative to the reference clothing approach is to provide specially designed reference strips. Each reference strip consists of a homogenous distinguishable color background and preferably marked with special reference marks. The ends of each reference strip is sewn with velcro in order for the strip to be attached to the appropriate location of the human body. The advantage of the reference strip is that the user is not required to put on the reference clothing before the picture is taken.

In order to provide a more accurate measurement of some specific body dimensional parameters such as waist and body height, the camera is preferably configured to travel up and down. The camera may also be motorized or positioned at different angles from the user, so as to take a picture of the user with different angles of view. Multiple visual pictures are then captured from the camera. The image data collected are processed to provide the parametric data describing the body profile of the user. It should be noted that multiple stationary cameras can be arranged to replace the moving camera and provide the similar data collection function.

When multiple facial images of the user and appropriate animated images of a garment are combined, the resulted animated images provide a personalized fashion coordination show. There are different data format and technologies available to provide the animation effect desired. Multiple garment images may be generated with the similar set up described above, by rendering technique or by computer assisted animation algorithms.

Once the user's body profile is established, the user is assigned an ID, which is for the servicing system to retrieve the specific body profile data file whenever this ID is presented. The ID may be in the form of numbers, alphanumeric words or and other form readable by a computer. The ID may come along with a security password, which prevents unauthorized use of the profile information. The body profile data file is typically stored in the memory area of a computer system. This memory area is typically represented by magnetic media, optical media or solid state media such as RAM, SRAM and flash memory. In field applications, the personalized ID is preferably to be stored onto a card or a tag. In this way every time the user visits a fashion store, he/she simply swipes the card with a reading machine without having to memorize the ID number. Alternatively, some key body profile parameters may be stored at the card as well, so that the machine reading the card is not required to connect to the central body profile memory storage system every time the data are to be retrieved. Other than the dimensional parameters describing the body profile of the user, the facial image data of the user is preferably held as a separate file linked with the same ID or stored together with the body profile in a similar data file.

Because the file size of the body profile parameters may be too big to be stored onto a card, a high compression BP coding method is disclosed herein so that users can remember or present his/her body measurements easily. If the facial image of the user is not included, the ID generated may be compressed or encoded such that one simple code number represents two or more measurement parameters. A simple BP code is extremely useful to enhance transportability, data storage and management of body measurements; and to improve the efficiency of garment manufacturing, inventory control and retail customer service. In a preferred Body Profile encoding system, a five to eight digit system should be able to represent all the measurements of a human body. Accordingly, every user having the same profile parameters will be allocated the same BP (Body Profile) code. For example, assuming a body profile system is defined to measure seven variables: neck circumference, shoulder width, arm length, chest circumference; waist circumference; hips size and inseam; and each parameter is quantized into nine different incremental measurements to service different body size users, the total possible combinations of these variables is 9⁷ (i.e. 4,782,969), which can be represented by a five digit alphanumeric number. The alphanumeric set can consist of 34 characters, i.e., numbers 0 to 9, and symbols A to Z, excluding letter O and letter I which are easy to be confused with the numbers 0 and 1. A four digit alphanumeric number will represent 1,336,336 combinations. A five digit number will give 45,435,424 combinations and a six digit code will provide 1,544,804,416 combinations. For example, a BP code “6RX3T” may represent the parameters of neck=3; shoulder width=4; arm length=4; chest=3; waist=3; hips=3 and inseam=5. The simplified number scale of each parameter is further referred to a look up table to obtain a specific measurement reading. For example, a number 4 neck circumference size is referred to 13 inches to 13.5 inches from the table and a waist number of 4 is referred to 24 inches to 25 inches. Alternatively, the coding system may be subdivided into “child size”, “ladies”, “gentlemen” and “big and tall”. In this way the number scale in each class may refer to a different dimensional table depending on the class used. It is believed that for child size, most numbers will be of small values; for big and tall people most numbers will be at the high end. As a result, a four to five digits BP (body profile) coding system may be adequate to service the system because many special combinations such as an extremely narrow waist and very big hips will be unreasonable. The number of possible parameters combined will be substantially less than the mathematical combinations of all variables by eliminating all the unreasonable combination of parameters. All the reasonable combinations left over is then encoded or decoded by a computer program according to a carefully designed algorithm to minimize coding and decoding computing time. This system is highly preferable because the body profile parameters can be organized by a standard computer program which can be encoded or decoded at any personal computer. Since everyone is sharing a standardized encoding and decoding system, the central body profile storage computer is thus eliminated.

During the research of the BP code program, it was discovered that there was no widely recognized standard garment sizing system available in the industry. Garment suppliers of different brand names using different size charts for their apparels. It means a person may find that the small size of brand A will fit his/her body, but for brand B, middle size is his/her fitting size. The collar size of a middle size shirt produced by brand A may be too narrow for another person and the sleeve of a brand B middle size may be too long for the same person. The deviation of garment size chart is more obvious when they are used in different countries, or different geographical locations. For example, the middle size of a garment in an Asian country may be treated as a small size in Germany. The middle size of a garment selling in USA may be larger than the large size of the same garment selling is South East Asia. Accordingly a unique and standardized BP coding system will facilitate unifying the varied size charts found in different areas of the world. This standard will simplify the barrier of international garment trading and also reducing the confusion and cost of the garment manufacturing and inventory keeping process.

The BP coding system is particularly suitable for internet garment sales and the purchasing of garment as a gift for a remote friend or relative. In a first preferred business mode of using the BP code, a person store a BP code at a location accessible by a second person. This location may be represented by an internet web site controlled by a pass word. The file containing the BP code may also store some other information related to this person such as the preferred color or style of garments. During the research of the BP code applications, it was also discovered that wrong fitting size and the hassle to return the products are the major obstacles for mail order and internet selling of garments to become popular. As a simple solution to minimize the chance of unfitted garment, the BP coding system is becoming a key force to promote direct marketing of garments through catalog, home shopping TV channels and also the internet. According to another preferred business mode making use of the BP code, a consumer may call her mother to get her BP code over the phone, then go to a store to select a preferred garment as a gift for mother's day. The store will try to fit the submitted BP code to obtain a recommended size of that garment according to the standard size chart of the store, and the fitting criteria defined for that particular garment style. The garment gift is then wrap up in a processing center and sent directly to the recipient before the mother's day, together with a card indicating who was the sender of the gift. The portability and simplicity of the BP coding system makes this business mode possible and ensuring that the gift garment will fit the recipient, that reduces the business cost of handling unnecessary return due to unfitted garment purchased. Alternately BP code of another person can be easily obtained through a letter, fax, internet or any other media of communication.

In further research of the BP coding system it was determined that the popularity of the BP coding system coexists with the different existing sizing systems used by the industry during the past time. Once the fitting criteria of physical body measurements and a specific size chart is defined, a simple fitting program may be used to recommend the optimal fitting size of a selected garment style.

According to another business mode of application, a garment retail store sets up a BP code servicing center inside the store. This center is equipped with automatic or manual body dimensional parameters measurement facilities. Trained personnel is also provided to make sure consistent and high quality measurements are obtained. Once the body measurements of a customer is obtained, the store may process the BP code for the customer by a local or remote computer. This BP code may be stored on a printed note, a bar code, a magnet strip card or stored at a remote digital storage such as an internet web site, ready to be retrieved by the users, their friends or their relatives. The benefits of this business mode to the consumer is that accurate body profile measurements can be obtained by professional personnel and facilities. The benefits of this business mode to the stores is that the store may make use of this service to increase traffic to the stores; and that consumer asking for BP code services are the more likely potential customers to purchase garments. The store may also make use of this opportunity to collect body size statistics of the consumer and track the preferred garment styles purchased by customers of different body sizes. This information will be very useful to develop new popular garment designs. Alternately, the store may conduct a simple marketing survey while offering a free of charge body profile measurement service.

While a BP code is a highly compressed code to represent a lengthy body measurement report, it is always a desire to put more information into the code while limiting it's length. Accordingly different kinds of compression algorithms capable to reduce the code length without sacrificing the information content are desirable. One of the techniques discovered during the BP code research is that many body measurements are in fact related to each other. For example, a person having a sleeve length of 30 inch will be very unusual to have an inseam of 18 inch. The most likely inseam for a person having a 30 inch sleeve is in between 26 to 32 inches. Assuming each of the inseam and sleeve length of a style of clothing has a range starting from 16 inches child size to 40 inch for the big and tall, separated by 0.5 inch increments, there are 49 possible values for each parameter. By introducing the relative concept in between the sleeve and the inseam measurements, we may make use of 49 increments to determine the sleeve dimension but only 13 possible offset values to derive the measurement of the inseam from the reported dimension of the sleeve.

It should be noted that the zero offset of one parameter may not required to be the same dimensional value as the reference parameter. For example, a 30 inch waist dimension may be defined to have a zero offset with a 15 inch neck circumference. One increment offset of this waist dimension for the neck is therefore computed to be 15.5 inch with a predefined 0.5 inch increment. Offset can be in one direction or having a polarity sign. Once the offset concept is established, all these variations can be easily computed by a simple computer program easily composed by a skillful person in the trade.

Another concept developed during the development research of BP code is a nonlinear quantization technique to define the incremental values of a quantized parameter. For example, the sleeve length of a shirt may be quantized at ¼ inch intervals for the child size range, ½ inch interval for the standard range and 1 inch interval for the plus size range. In this way, the range of a parameter is under control while enabling the system to satisfy the needs of different body sizes.

The concept of offset in BP code formation is also applicable to define fitting variation from a standard size chart. The definition of garment fitting is sometimes a variable according to different fitting criteria of different garment style. Assuming the properly fitted length of a pair of pants is for the lower ends of the pants to stay around 0.5 inch above ground level, it may be possible for a designer to create a trendy style that having the lower ends of the pants to stay consistently 12 inches above the ground level. Alternately another designer may create another trendy style which requires the pants to be around three quarter length of a standard pants dimension. If an everlasting fitting criteria is defined for a BP code to fit a standard size chart, it is required to add into the system a supplemental BP code related fitting structure to take care of all the style oriented deviations from the standard parameters. For the above mentioned example, we may add into the fitting algorithm or the garment BP code an offset of minus 12 inches or minus one quarter pants length. These intentional offset values are applicable only for the particular style of pants specified.

In order to provide room in the BP code system to specify the particular style dependent offset value, a supplemental code is then recommended to specify the nature of the variation, and the magnitude of the variation. For example, the BP code of a pair of pants may comprise of a four digits primary code to describe the dimension of the pants according to the traditional standard, and another 2 digits supplemental code to define the offset required by a particular style of the pants design. The first digit of the supplement code may define the nature of the offset, such as a fix amount reduction in length or a proportional length reduction. The second digit may be used to specify the magnitude of the reduction. When the numbers 0 to 9 and the alphabets A to Z, excluding the letters O and I are used to define a digit of the code, there are 34 possible combinations for each digit. It means there are 34 possible offset styles and each styles has 34 possible dimensional offset values. Although the primary code is supposed to be capable of being used independently, it is preferable to include in the first four digits primary code a message that a supplemental code is to follow. This can be obtained by adding a two variables parameter into the primary encoding system. The first variable of the added parameter indicates that there is no supplemental code to follow. The second variable indicates that a supplemental code is to be included when the BP code is to be processed. Alternately, we can define that the maximum count of a particular parameter indicates that a supplemental code is to follow.

The concept of supplemental code gives flexibility to the BP coding system without affecting the function of the primary code. There are many other applications of the supplemental code designs useful for providing additional information to the system. This optional expanded coding system provides flexibility and room for the BP coding system to grow in the future.

It should be noted that many of the aforementioned compression skills and variations from the standard BP code are predefined conditions or pre-computer activities before a computing apparatus is used to decode or fit a BP code with a size chart.

The novel features of the invention are set forth with particularity in the appended claims. The invention will best be understood from the following description, when read in conjunction with the accompanying drawings.

### DESCRIPTION OF THE DRAWINGS

FIG. 1 is a front view of a floor stand having an electronics display device;

FIG. 2 is a side view of FIG. 1 together with a computer and controller;

FIG. 3 is an image capture setup configured to generate parametric data describing a body profile;

FIG. 4 is another image capture setup with the camera facing the user at different orientations;

FIG. 5 demonstrates the design of a reference clothing;

FIG. 6 demonstrates the design of a reference strip;

FIG. 7 illustrates the combination of the facial image of a user with the garment image of different BP coded sizes;

FIG. 8 shows a remote computer linked with a image capturing kiosk located at a point of sale or a home computer connected through communication channels.

FIG. 9 illustrates an embodiment of a servicing terminal to be located at the store offering the invented services;

FIG. 10 illustrates an embodiment of the server system established at different companies to participate in the invented information sharing system;

FIG. 11 illustrates the relationship between a body measurement list and an encoded/compressed number to represent said body measurement list;

FIG. 12 illustrates the flow chart to produce a BP code;

FIG. 13 shows a flow chart to decode a BP code to provide a detailed list of body measurements;

FIG. 14 illustrates the flow chart to produce a BP code for a garment;

FIG. 15 illustrates an application example how the BP code of a user and that of a garment are handled by a computer to assist garment purchasing decisions;

FIG. 16 illustrates the format of a portable media storing the BP code;

FIG. 17 illustrates the structure of a primary code and a supplemental code;

FIG. 18 illustrates a parameter table representing the values of sleeve length and another parameter table representing the values of inseam;

FIG. 19 illustrates a standard size chart of a typical existing garment; and

FIG. 20 illustrates the concept of offset parameters.

### DETAILED DESCRIPTION

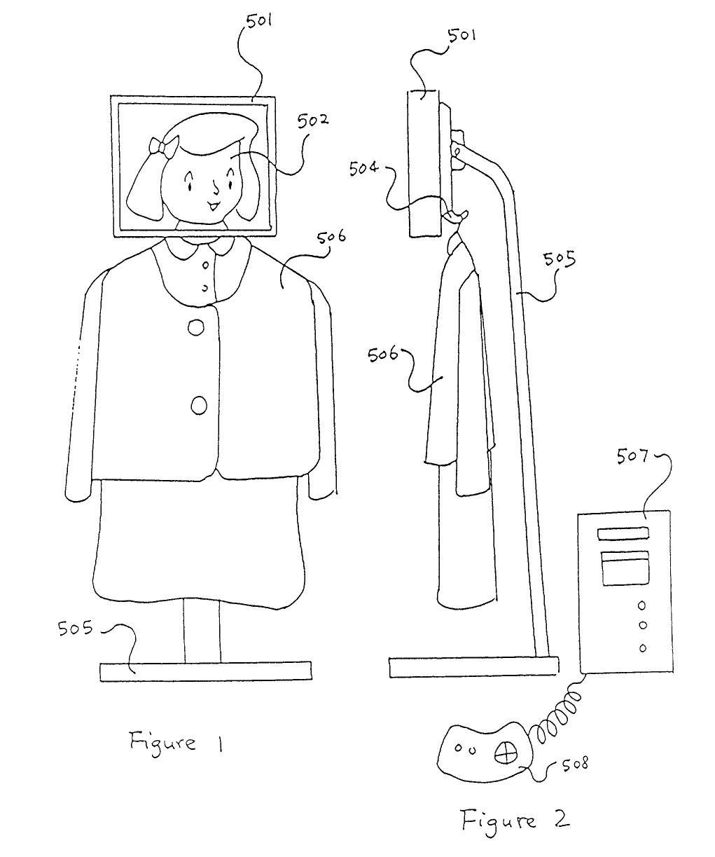

Attention is initially directed to a system having a library of facial images of users, which are useful to enable a user to experience life like virtual garment coordination with a selected garment. The user image can be obtained by scanning the photograph of a user or by capturing a digital facial image of the user by a digital camera. Attention is now directed to an exemplary set up disclosed in applicant's priority application. FIG. 1 depicts an embodiment having an image displaying region represented by an electronics display device such as a computer monitor. The electronics display device 501 is supported by the floor stand 505. The facial image 502 of a user is displayed on the screen. A garment 506 is positioned beneath the facial image displayed. An LCD monitor is preferred due to its thin profile and light weight. FIG. 2 is the side view of the set up shown in FIG. 10. A receiver 504 located behind the display region receives the hook member of the hanger supporting the garment 506. The computing device 507 converts the digital facial imager of a person and displays it on the electronics display device 501. The computing device 507 may receive the image data from a remote computer storing a library of facial images. A controller or input device 508 enables users to key in their own code word and fetch their own personalized facial images to be displayed onto the display screen. The input device can also be used to modify the presentation of the facial image such as modifying the color balance and adjusting the relative position of the image.

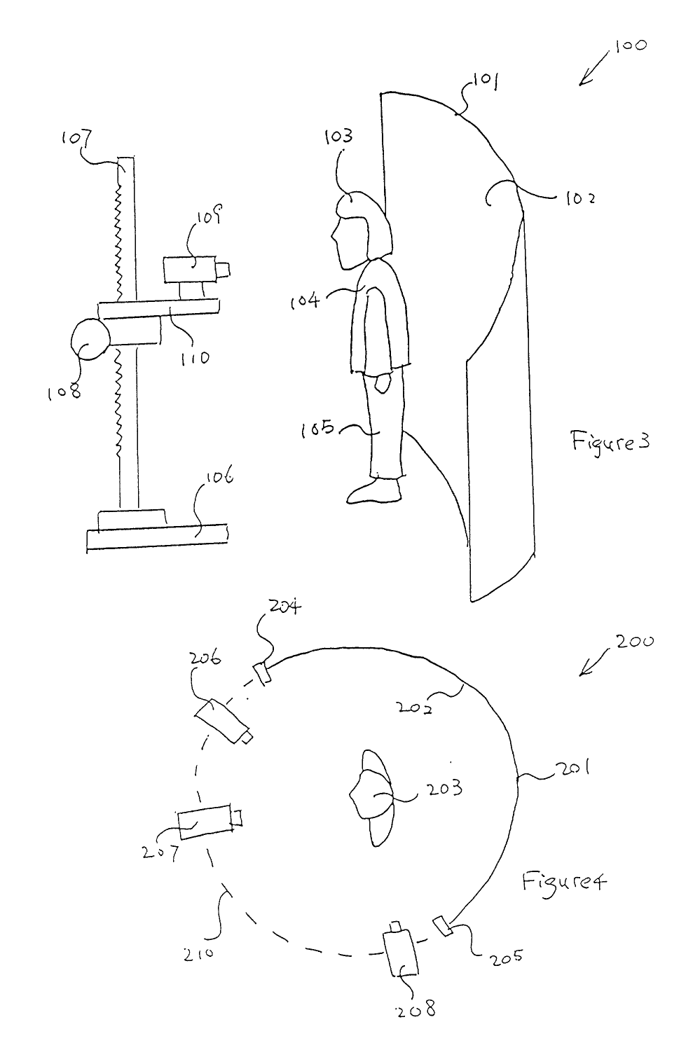

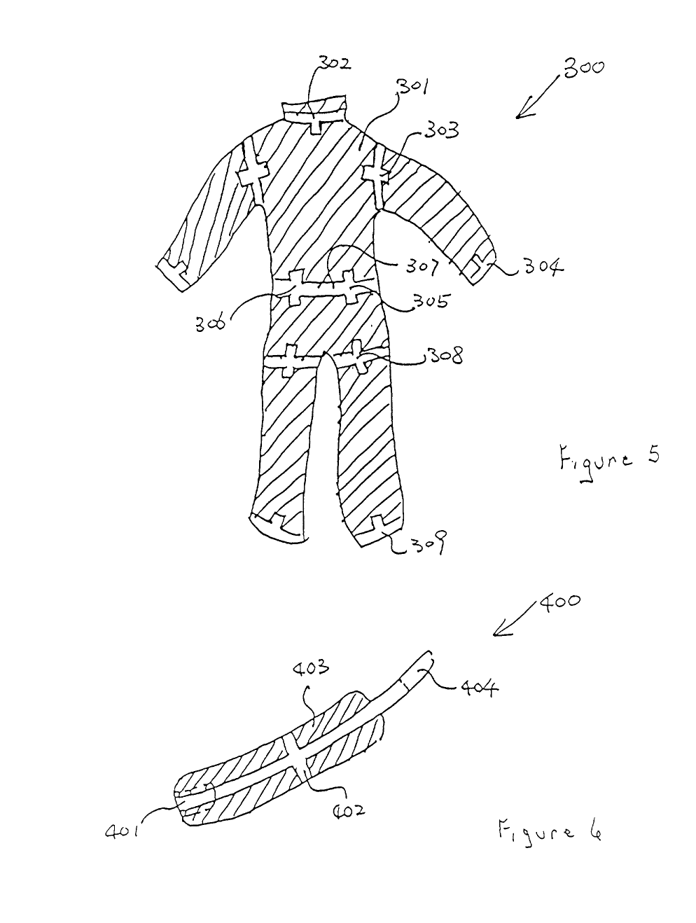

FIG. 3 demonstrates a set up for a camera to capture the facial and body images of the user. The user having a facial portion 103, an upper torso 104 and a lower torso 105 stands in front of a background wall 101. In front of the user is a digital camera 109 which rests on a supporting mechanism 110. The supporting mechanism is mounted on a pole 107 and is configured to travel up or down along the pole by the driving force supplied by a motor 108. The pole 107 is supported by a platform or podium 106. The camera 109 captures a facial image 103 of the user having a non-interfering background 102. The digital data representing the facial image of the user is then sent to an image processing computing device (not shown) configured to eliminate the background picture and extract the facial image. When the camera 109 is adjusted by the motor 108 to a lower level, a picture of the upper and lower torso of the user can be captured. A calibrated input vernier measuring the height of the camera from the floor can be used to provide data describing various body profile parameters of the user, such as the body height and leg length. Multiple cameras positioned at different locations may be set up to replace a movable camera to improve the facility reliability. The face or head size of the user can be obtained by measuring electronically or manually the facial image of the user. Since various parameters are to be measured according to the pictures captured, the background of the picture should be controlled, in order for the computer supported image extraction mechanism to work properly. The non-interfering background refers to any background which does not interfere with the activity of the camera and computer to measure the body dimension of the object human body. The requirement of a non-interfering background varies according to the hardware and software algorithm of the image processing computer. A typical example of a non-interfering background is a blue color wall commonly used for the traditional chroma keying effect in TV recording studios. In this system, any relative pure non-blue image signal received will be discarded. Eventually an outline of the body can be defined. Alternatively, it may be a pure white background distinguishable by the camera and the specific measurement method utilized by the system to achieve the measurement goal. If multiple pictures and relative movement between the person and the camera are provided, the measurement can be achieved by interpolation of the body profile data collected at different viewing angles. Due to continuously increasing improvement of DSP and software interpolation technology, it is expected that in the future, the non-interfering background can be any stored background without having a specific color or lighting requirement. In order to obtain a consistent data extraction effect, the light illuminating the user and the non-interfering background are preferably also controlled.

FIG. 4 illustrates an enhanced arrangement of FIG. 3 in which the podium 106 is motorized to travel around the user 203 along the path 210. With this arrangement, multiple views of the user from different angles 206, 207 and 208 are captured to generate facial images from different angles of view. Multiple angle snap shots are also required to enable the computer supported system to more accurately measure or calculate many important parameters of the user body profile, such as the chest size, the waist size and the hips size. Another way to obtain multiple angle snap shots is to arrange multiple cameras 206, 207 and 208. Alternatively a controlled turn table may be placed beneath the user so that the position of the user is rotated instead of the position of the camera to obtain the same effects. If continuous pictures are captured, the playback facial image can be used to combine with animated garment images to provide a movie like fashion show effect.

When the body outlines obtained from different angles of view, distinguishable from the non-interfering background are processed by the supporting computer, a family of parameters describing the body profile of the user can be indirectly calculated. Various imaging processing or interpolation techniques and DSP algorithms are available to calculate indirectly the values of these parameters. Image processing means in this application is defined by any computer supported apparatus, equipped by specific hardware or software, or both, able to process the image data in order to obtain the result or data desired, in accordance with the image processing criteria predefined. In many situations, an image processor may require manual assistance to obtain the most accurate result. For example, in order to simplify the calculation process and reduce the cost of the processing system, an image processing result can be obtained by requiring the user to put on a specially designed reference clothing 300 illustrated in FIG. 5. The reference clothing 300 is preferably made of a homogenous elastic material to accurately reflect the body curvature of the user. Highly distinguishable reference marks 302, 303, 304, 307 308 and 309 are preferably added to highlight the critical reference points of the user body. Many parameters can then be calculated by measuring the distance between these reference marks. For example, the arm length can be obtained by measuring the distance between the reference marks 303 and 304. The waist size can be calculated by measuring the extended width of the reference mark 307. The inseam can be read by measuring the distance between the reference marks 308 and 309. In order to obtain higher measurement accuracy, special marking shapes can be added onto the reference marks to facilitate the computer automated measurement job. For example, cross shape marks 305 and 306 are added onto the reference mark 307 for measuring the inseam. When three dimensional parameters are measured, more than one pictures of the user wearing the reference clothing is recommended to be taken from different viewing angles. The data obtained from these pictures are to be processed altogether to obtain the body profile parameters indirectly.

FIG. 6 illustrates the design of reference strips, which can be put onto the regular clothing of users to obtain the similar effect of the reference clothing of FIG. 5. The reference strip 400 comprises a dark background 403 and a highlighted area 402. Velcro strips are added to the ends of the reference strips to enable the reference strips to be attached to the appropriate location of the user body, such as the waist and the arm. The detachable reference strips are preferred over the reference clothing because the user is not required to put on the appropriately sized reference clothing before the picture can be captured.

It should be noted that the style and shape of the reference clothing and reference strips are exemplary. Different shape, style and design capable of serving a similar function are included in the scope of this invention. Other than a fully automated system, manual assisted measurement is recommended to correct some particular measured parameters which tend to have a higher error rate. Alternatively, users can measure their own body profile parameters, record the measurements on a check list; and then enter the data into a terminal to establish their body profile file in the system and to obtain the ID code.

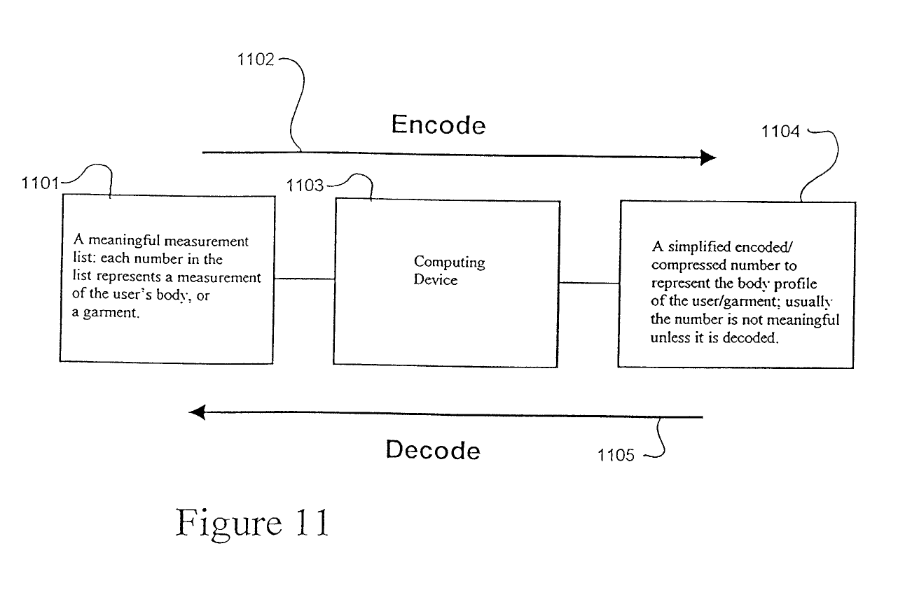

Attention is now drawn to FIG. 11 which illustrates the basic system to convert all the actual physical measurements of a user body and encode them into a single body profile (BP) code. The BP code is highly compressed for easier portability and handling by users and the retail stores during shopping. During the encoding process 1102, the physical measurements of a user, or a garment, are processed by a computer 1103 according to a suitable encoding algorithm. The output is a simple code represented by the block 1104. The highly compressed BP code usually does not have any physical meaning by it self unless it is used to reproduce a detail body measurement list through the decoding process 1105.

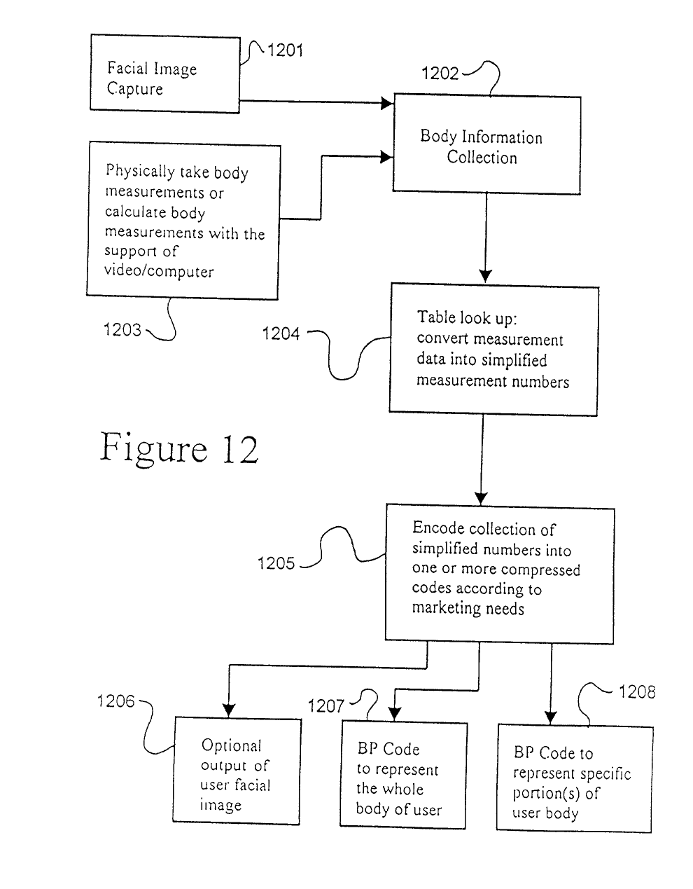

FIG. 12 illustrates a more detailed picture of the BP encoding system of a human body. The body measurements of the human body is obtained manually by a tape measure, or by the video/computer supported high speed body measurement system previously discussed. As an option, the facial image of the user is also captured by a camera and provided in the format of digital data. The physical body measurements then go through a table look up as represented by the block 1204, either manually or through a computer program. Each measured parameter is assigned a simple quantized number by the table. For example, a neck dimension of 15 inch is represented by a quantized number 5 and a neck size of 15.5 inches is assigned a quantized number 6. All the simplified numbers of different parameters are then compressed to form a very simple single code represented by 1207, that can be easily handled or carried around. Alternately, different BP codes can be generated according to different portions of the human body. For example, a first BP code can be encoded to represent the upper torso of the user and a second BP code to represent the lower torso. The upper code is useful for shopping shirts and jackets, but not for pants. A data file 1206 representing the facial image of the user is useful to demonstrate virtual pictorial fitting presentation to the user during garment shopping.

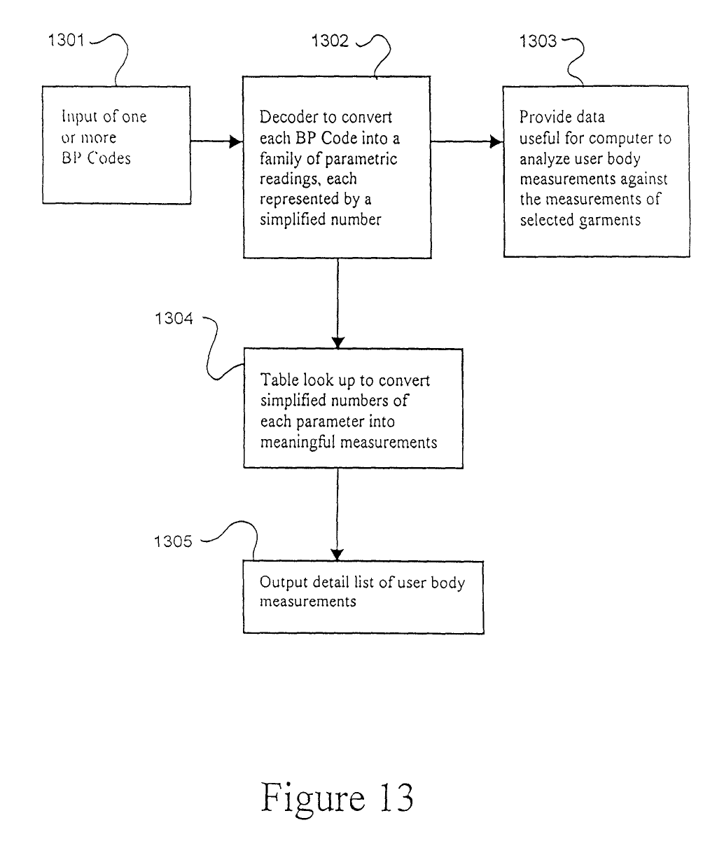

FIG. 13 illustrates how the BP code is handled during the shopping process. The store is not required to take body measurements of the user. The BP code of the user is simply fetched from an ID card, or from a computer database. The code then goes through a decoding process to obtain the simplified numbers, each representing the measurement of a human body parameter. These data, though perhaps not meaningful for human interpretation, are often useful for computer analysis; such as comparing the fitting with the dimensional information of a garment. If human visual reading is required, the code is further translated by a reverse look up table process as shown in 1304 for recovering the full body measurement list.

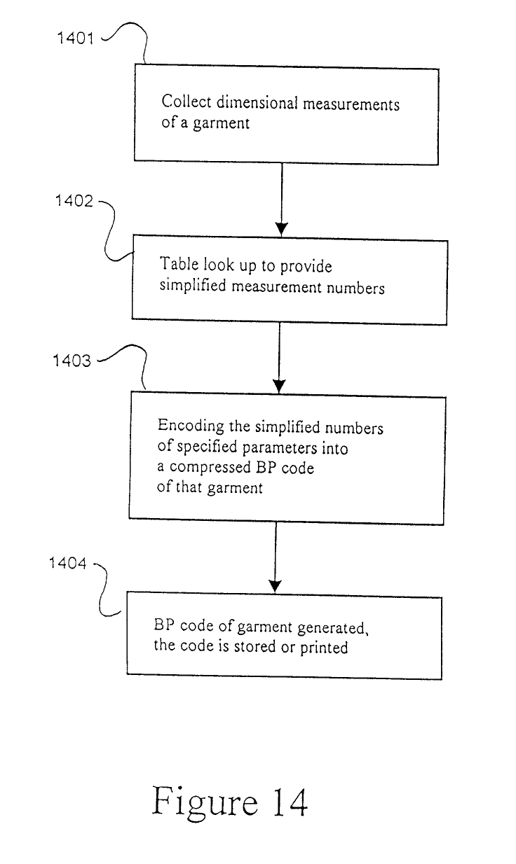

FIG. 14 illustrates the process to produce the BP code for a garment. An image file of the garment is preferably associated with the garment BP code to enable the system to produce a virtual garment fitting presentation when the particular garment is selected by a user. This image file can be stored in the central computer or server of the retail store. For cost reasons, a very simple BP system is desirable for mass merchandise garment articles. The BP code of each garment is preferably printed on the hang tag attached to a garment. The user or servicing staff of the store may then make use of this garment BP code to help determine if the garment fits with the body profile of the customer.

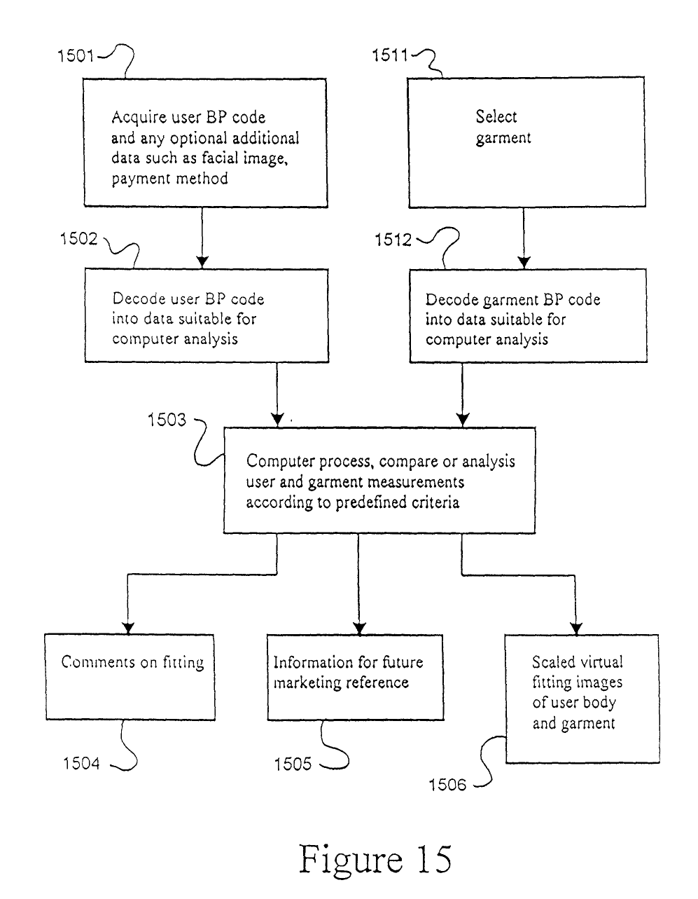

FIG. 15 illustrates the shopping process supported by the BP codes of users and the garments. The BP codes acquired are fed into blocks 1502 and 1512 for decoding into further detailed numbers suitable for computer analysis or presentation. The output of the computer may be comments showing which part of the garment may have a fitting problem according to the BP code of the user received. A file of statistical data may also be created to support future market research. The system may provide valuable data to support marketing; such as the distribution of the body sizes; customer buying habits and the clothing preferences of customers with different sizes. For example, the system may provide a report concluding that taller girls prefer looser clothing. If the media carrying the user BP code is supported with user facial image data, a virtual fashion show can be provided to give users better ideas of how the garment will fit their bodies.

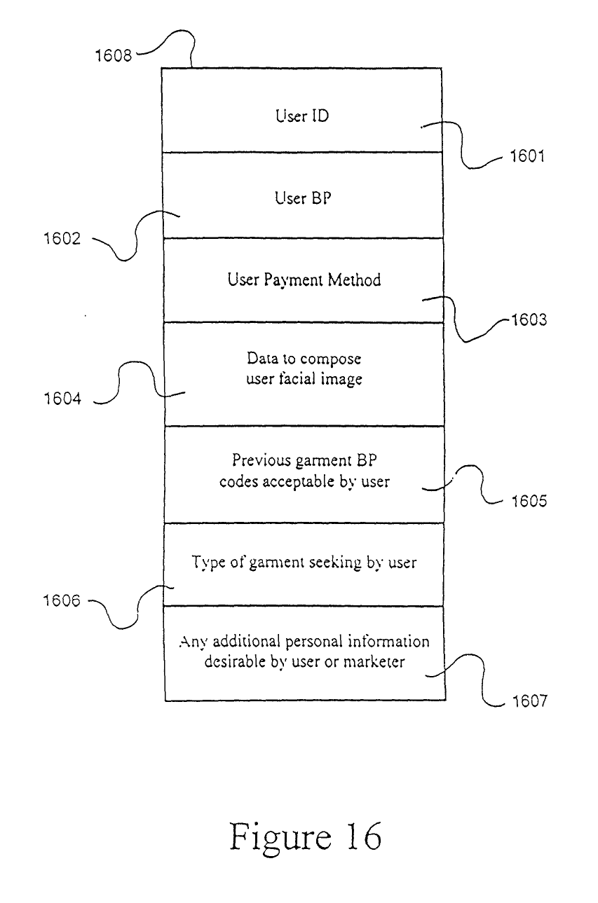

FIG. 16 shows an embodiment of a portable storage media which can be carried by a user for shopping assistance. The media 1608 can be simply a card printed with the user's BP code 1602, or using a bar code to represent the BP code. Alternately, a full featured portable media can comprise a magnetic strip, optical or solid state rewritable memory. With higher storage capacity, more personal information of the user such as the facial image 1604, credit card or direct account information 1603, acceptable garment BP code criteria 1605 or any other additional information desired by the user or the marketer to facilitate the shopping process. It is also possible for the user to make use of this portable media to combine the internet and store shopping modes. The user may access the web site of the store and preselect certain garments. The information about these preselections is then entered into the portable media (e.g. a floppy diskette) by the home computer of the user. When the user present this portable media at a store, it can be read by the store computer to efficiently direct the sales person to service the user according to the wish list recorded in the portable media.

A high capacity portable media can store more user information allowing for better quality and higher efficiency services to improve the shopping experience of the user. Alternatively, multiple user information, each similar to the content of the portable media 1608 can be stored on a single portable media, so that a mother can do the shopping for every member of the family with the support of a single media.

In an ideal Body Profile encoding system, a five to eight digit system should be able to represent all the measurements of a human body. Accordingly, every user having the same profile parameters will be allocated the same BP (Body Profile) code. For example, assuming a body profile system is defined to measure seven variables: neck circumference, shoulder width, arm length, chest circumference; waist circumference; hips size and inseam; and each parameter is quantized into nine different incremental measurements to service different body size users, the total possible combinations of these variables is 9⁷ (i.e. 4,782,969), which can be represented by a five digit alphanumeric number. The alphanumeric set can consist of 34 characters, i.e., numbers 0 to 9, and symbols A to Z, excluding letter 0 and letter I which are easy to be confused with the numbers 0 and 1. A four digit alphanumeric number will represent 1,336,336 combinations. A five digit number will give 45,435,424 combinations and a six digit code will provide 1,544,804,416 combinations. For example, a BP code “6RX3T” may represent the parameters of neck=3; shoulder width=4; arm length=4; chest=3; waist=3; hips=3 and inseam=5. The simplified number scale of each parameter is further referred to a look up table to obtain a specific measurement reading. For example, a number 4 neck circumference size is referred to 13 inches to 13.5 inches from the table and a waist number of 4 is referred to 24 inches to 25 inches. Alternatively, the coding system may be subdivided into “child size”, “ladies”, “gentlemen” and “big and tall”. In this way the number scale in each class may refer to a different dimensional table, depends on the class used. It is believed that for child size, most numbers will be of small values; for big and tall people most numbers will be at the high end. As a result, a four to five digits BP (body profile) coding system may be adequate to service the system because many special combinations such as a extremely narrow waist and very big hips will be unreasonable. The number of possible parameters combined will be substantially less than the mathematical combinations of all variables by eliminating all the unreasonable combination of parameters. All the reasonable combinations left over is then encoded and/or decoded by a computer program according to a carefully designed algorithm to minimize coding and decoding computing time. This system is preferable because the body profile parameters can be organized by a standard computer program which can be encoded and/or decoded at any personal computer. Since everyone is sharing a standardized encoding and decoding system, the need for a central body profile storage computer is thus eliminated.

Another embodiment of encoding and decoding the BP number can be organized as follow:

Assuming the body profiles of men are described by the following parameters:

A. Arm length: 24 inches to 32 inches in 16 quantization levels, i.e., increments; e.g., 24 inches translates to an increment, i.e., reading of 0, 25 inches has a reading of 1, 26 inches has a reading of 2 and so on.

B. Neck diameter: 13 inches to 19 inches in 12 increments.

C. Torso length: 24 inches to 32 inches in 8 increments.

D. Waist diameter: 27 inches to 40 inches in 13 increments.

E. Leg length: 28 inches to 42 inches in 14 increments.

Assume a body profile for an exemplary user to be represented by the following data:

a. Arm length: 26 inches (reading 2).

b. Neck diameter: 15 inches (reading 2).

c. Torso length: 25 inches (reading 1).

d. Waist diameter: 30 inches (reading 3).

e. Leg length: 28 inches (reading 0).

For the convenience of presentation, the BP code generated for the above profile data will be represented by a ten based number as follows:

(((((((2×16)+0)×14)+3)×13)+2)×12)+1=70381

The term (2×16) represents the arm length which has 16 increments and a reading of 2. The next addition (0) and multiplication 14 refers to the next parameter having the next highest range of increments, i.e., leg length. The leg length of the user has a reading of “0” and 14 possible increments can be used to describe the leg length. The next parameter handled is the waist diameter, which has 13 possible increments and a reading of 3. The next parameter handled is the neck diameter which has 12 possible increments and a reading of 2. The last parameter handled is torso length which has 8 possible increments and a reading of 1.

The BP code 70381 will uniquely describe the body profile of a man to have an arm length of 26 inches; neck diameter 15 inches; torso length 25 inches; waist diameter 30 inches and leg length 28 inches. To decode the number 70381 to retrieve the individual readings, the following reversing operation can be performed:

(1) Dividing 70381 by 12, a quotient of 5865 and remainder of 1 is obtained. The remainder 1 refers to the code reading of the torso length and represents an actual torso length of 25 inches.

(2) Dividing the number 5865 by 13 to obtain a quotient 451 and a remainder 2. The remainder 2 refers to the code reading of the neck diameter and represents a neck diameter of 15 inches.

(3) Dividing the number 451 by 14 and obtain a quotient of 32 and a remainder of 3. Accordingly the number 3 refers to a waist diameter of 30 inches.

(4) Dividing the number 32 by 16 and obtain a quotient of 2 and remainder 0. The remainder “0” represents the leg length of 28 inches and the last quotient 2 represents the arm length of 26 inches.

It should be noted in the above encoding process that the parameters are handled in sequence from the parameter having the highest number of increments to the parameter having the fewest number of increments.

The foregoing exemplary encoding process produces a BP code comprised of a digits within a base 10 system (i.e., 0-9). In an alternative and preferred embodiment, a base 34 system (alphanumeric) is used in which the BP code digits can be represented by any of the integers 0-9 and letters A-Z (excluding the letters “I” and “O” to avoid confusion with the integers “1” and “0”).

Alternatively, the BP code may be comprised of more than one compressed code to represent the body measurements of a user. For example, a BP code may be comprised of four different sub-BP codes expressed in series. Each sub-BP code respectively represents the upper torso measurements, the lower torso measurements, the measurements of the head, and the measurements of the feet. The sub-BP codes are therefore suitable for the user to fit shirts/jackets; pants/skirts; hats and shoes respectively. Other than enriching the BP code by the type of garment to be fitted, additional non-size related codes can be added to the BP coding system to identify other personalized parameters of the user, such as color preference, material preference, purchasing habit and even information related to the frequently used credit card.

Accordingly, the virtual garment coordination process by means of BP coding comprises the procedure to decode the BP code of the user. The decoded body measurement is then compared with size data related to a target garment. The size data of the target garment may also be decoded from another BP code representing the parameter measurements of the target garment. The output portion of the virtual garment coordination process equipped with the BP coding system may be visually supported by a display screen capable of presenting a picture of the user's body compared with pictures of the target garments. Different sizes and styles of the target garments can be provided to provide the virtual coordination and fitting effects. Visual messages providing recommendations may also be provided on the screen or by a printer. Alternatively, these messages can be provided by voice producing devices.

A facial image can be included in a hybrid system which utilizes the BP code described above in conjunction with a personalized coding portion for the computer to retrieve the personalized facial image or any other related personal data. This hybrid system enables the user to shop at both the stores offering the body profile system only and also stores offering the hybrid system with facial images.

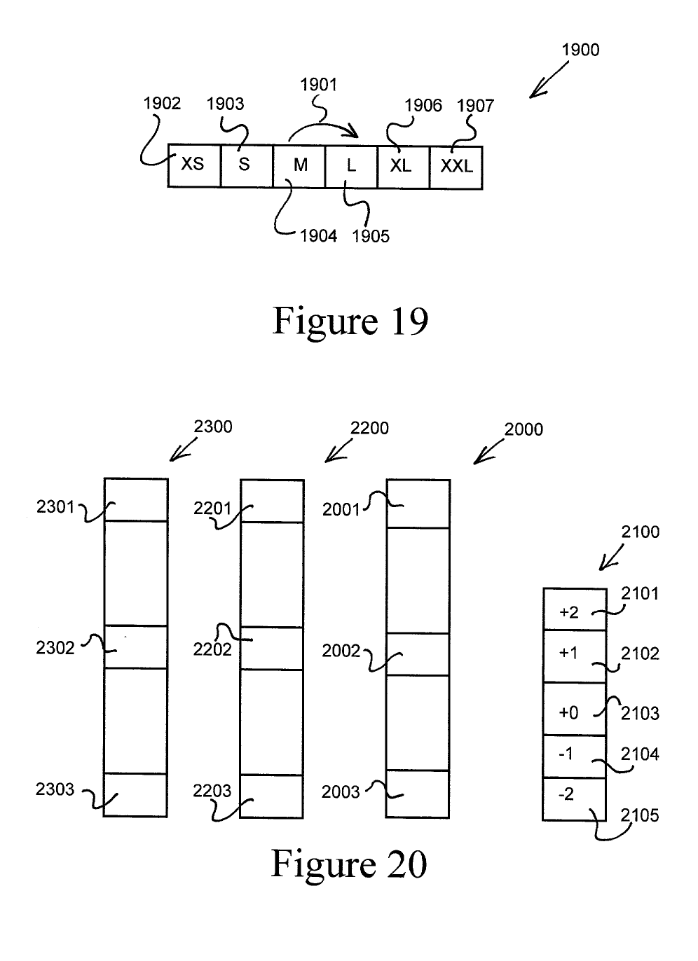

Presently in the stores, most garment are classified by a simplified standard size system described by XS, S, M, L, XL, and XXL sizes, as illustrated in FIG. 19. It should be noted that although many garments are supplied with simplified standard sizes, from time to time they are not of identical dimensions in all key parametric measurements due to variations in garment design, style and variation in fabric materials. The deviation is more serious when the garments are supplied by different manufacturers which may have a different way to interpret the standards of the simplified size system. It is a common problem that people buying a particular standard size garment often find minor incompatible dimensions and the garment purchased needs to be returned or modified. Therefore it is desirable for every garment to have its detailed dimensions specified and uniformly encoded with a simple BP code as described herein. With the BP coding method, the detail dimensions of the simplified standard size garments can be retrieved from any computer. This enables a garment to be faithfully represented when displayed in systems in accordance with the present invention. Since the body profile of a user faithfully reconstructs the dimensional structure of the virtual body to be displayed in the virtual coordination system, the simplified size garment displayed may not match perfectly with the body image constructed of the user. The virtual coordination system is therefore very useful for the user to try garments of different simplified standard sizes and to evaluate which standard size of the garment provides the best fitting to the user according to the body profile submitted. Alternatively, a program with specific criteria and algorithm can be used to determine if minor discrepancies between a standard size garment and the body profile of a user is tolerable. For example, an algorithm may be defined such that the neck circumference of a shirt should never be smaller than that of a user, and the waist dimension of a shirt should be one to two inches wider than that of a user. An actual BP coding system for garments preferably takes into account different garment types such as shirt, T shirt and trousers. This is because different types of garments may have a different size screening criteria. The different garment types may result in generating another coding parameter just for identifying the garment type. Alternately, other non-size related parameter can be added into the garment BP code to identify other characteristics of the garment, such as color and material variations.

With the support of the BP code screening system, customers are happy, as all purchases going through the BP code screening system are predictable. The retail stores and garment suppliers are happier, because fewer returns are to be anticipated.

In a first application scenario, a user visits a store and enters his BP code or swipes his card through a reading machine. The store computing system retrieves the body profile of the user and recommends some suitable garment to the user. Alternatively, the user may key in the preference characteristics of the target garment such as type of garment, color and price range; then the servicing computer makes use of the body profile data of the user to scan through the inventory of the store to see if a garment matching all these requirements is available. The images of all suitable garments are then displayed on a displaying screen for viewing by the user one by one. If the facial image of the user is available in the system, the displaying screen can be configured to display a real life fashion show, showing the looking of the user properly coordinated with different kind of available garments. Eventually when the user selecs a particular design of the garment, the screen can tell the user where the selected garment can be located for pick up.

In a second application scenario, a user visits another store. The user swipes his card through a reading machine. The store computing system retrieves the body profile of the user and recommends some special garment design suitable for the specific body style of the user. For example, the pattern of the garment may be on long vertical stripes if the body size of the user is wide. Garments of horizontal stripes are recommended for thin and tall bodies. A virtual fashion show showing the picture of the using dressing in each of the recommended garments is displayed one by one on a displaying screen. Alternatively, the user may conduct a window shopping and browse through different garment designs offered by the store. When a desirable garment is located, the system will adjust the visual image of the garment according to the body profile retrieved and combine it with the facial image of the user. A virtual personalized picture of the user putting on the selected garment is then displayed for virtual coordination purpose. After the user determines which garment to buy, the computer system checks if inventory suitable for the body profile of the user is available. If stock is not available, the computer system generates a purchase order, which goes along with the body profile parameters to the factory servicing the store. The garment ordered by the user is then manufactured. An alternative application of this scenario is for the store to keep fabric samples and offer custom tailor clothing to every customer using the system. If the servicing system is connected to the manufacturing system of a computer supported manufacturing factory, the body profile data of the user can be fed to the fabric cutting machine located at the factory. The raw fabric material is then planned and cut into different fabric components according to the body profile dimensions of the user and also the design pattern of the garment design selected. When multiple orders of similar design pattern are received such as in large scale production of school uniforms, the body profile of the users will enable the computer aided manufacturing machine of the factory to optimize the fabric pattern arrangement on the fixed dimension raw fabric materials, such that minimal fabric materials will be used to fulfill the order.

In a third application scenario the user logs in at a garment retailing web site through her/his home computer. The user keys in the personalized body profile ID, and then the keywords describing the target garments looking for, such as color, type, price etc. The web site returns with garment images meeting all these requirements. The stock checking procedure or custom tailor procedure described above if the sale is to be concluded. For internet applications, the resolution of the image to be transmitted through the communication link is preferable to be of a lower resolution in order to reduce the response time required to fetch the downloaded images. Typically a resolution of 5 kB to 20 kB is adequate for such applications. In contrast, if all the facial image and the garment images are retrieved from a local system, the resolution of the images can be increased to provide higher quality garment coordination pictures. It is submitted that the system is not only suitable for customers to shop for suitable garments in a store, it is very important to support internet garment retail business as it enables the customers to purchase perfect fitting garment without actual seeing the product.

Since the facial image of the users, the body profile parameter data, the garment image files and related personal data are all stored in memory storage areas, the location of the memory storage areas is critical when the data stored are to be transferred from one location to another. Although these data may be stored in the same memory area of a system or remote from each other, they are preferably to be located to minimize data transferring, so as to improve response time. For example, in internet applications, the facial image data is recommended to be stored at the local computer and the garment image information can be stored at a remote centralized computer.

It should be noted that the automated camera supported, body profile generating system disclosed is an efficient way to collect the body profile for a big number of customers at a time. Manual assisted measurement is recommended to correct some particular measured parameters which tend to have a higher error rate. Alternatively, users are recommended to measure their own body profile parameters, record the measurements on a check list; and then enter the data into a terminal to establish their body profile file in the system and to obtain the ID code. In this way the data stored in the system will be of high accuracy. Another advantage of the independent BP coding system is that the data are independent and not stored in the database inside any centralized system. The user is therefore free to modify the parameters whenever required, without having to update the data file recorded in a central system. The BP coding system invented provided a simple and effective mechanism for user to update the data from time to time. This mechanism is required because the body shapes of a human being seldom remain unchanged for an extended period of time.

When the body profile parameter includes the head size, the system is useful to provide shopping support of hats and caps. When the body profile parameter includes the feet size, the system is useful to provide shopping support of shoes. It is foreseeable that once the system is accepted by the consumers and retailers, more information about the users, such as user preference and shopping pattern, may be included or attached to the BP coding file.

It should be noted that the shape and size of the garment generated for coordination purpose is preferably to be scaleable. That is the body shape and size be adjusted according to the BP decoded data of the user, in order to generate a life like coordination effect. In the situation a BP code is not entered into the system, the default or nominal garment size will be displayed.

The BP coding system is useful for many other applications, such as for a fashion designer to custom design an apparel for a user. The fashion designer may start from a body image reconstructed from the data derived from the BP coding data file of the user. This image is preferably to be of three dimensional nature and including the 3D facial images of the user. By using suitable 3D rendering technique, the fashion designer can interactively trying different design portions of the fashion with the 3D life like body model generated. A typical design process includes pasting different designs of fabric, pattern, color and shapes of fabric onto the body model. The principle of computer supported 3D rendering is well known in the art and therefore not to be further elaborated in this application.

Another alternative application of the body profile system is for the data and/or encoded BP number to be collected over different period of time, the different data collected versus time is then compared with some pre-established data base to analyze if the change of body profile indicates any abnormality or a caution of health signal is to be highlighted. For example, the body profile of a baby measured at different time period can be collected to compare with pre-established data of baby growth curve to determine if the baby is growing normally. Alternatively, the parent may make use of the body profile data collected from the baby to predict what size of clothing is to be purchased six months later. The encoded BP code conveniently enables the parent to look forward or predict the size of the baby at a later time. Similarly, a pregnant mother may make use of the early BP code to prepare maternity clothing to be used at a later time. Alternatively, doctors may analyze the changing BP codes to predict the likely birth dates of a pregnant woman. In order to accurate predicting the change of body profile, some special parameters such as the body weight can be added to the BP parameter list. With the support of reference data base, the BP system can be conveniently used to monitor normality of change in body profile or predicting the body size in the future time.

Since users can use the BP codes and facial images to facilitate garment shopping at different stores, it is convenient and economic to structure a servicing system for enabling multiple garment stores and/or web sites to share the same data base. In one embodiment of the system, the sharing data such as the image data is stored at a centralized servicing system and the data is to be shared by all the participating stores and web sites. Alternatively the sharing data may be stored at the server of any participating store or web site and the directory information is then shared with all other stores and web sites so that the data can be shared when a request of service is received. Preferably a master servicing system is also established to handle the updating of the sharing data.

It should be noted that the computing apparatus, computing device, computing system referred in this application may comprise a terminal, a processor, a single computer, or a network of computers which are combined to service a specific function.

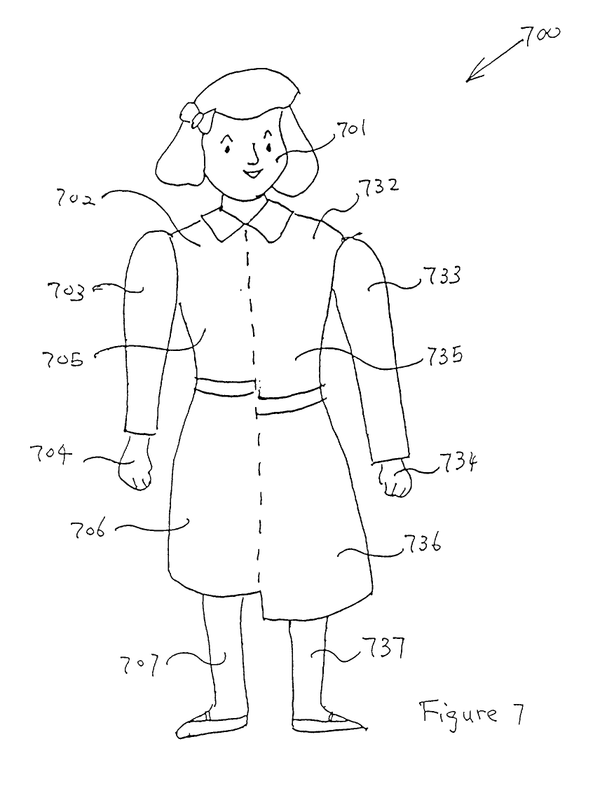

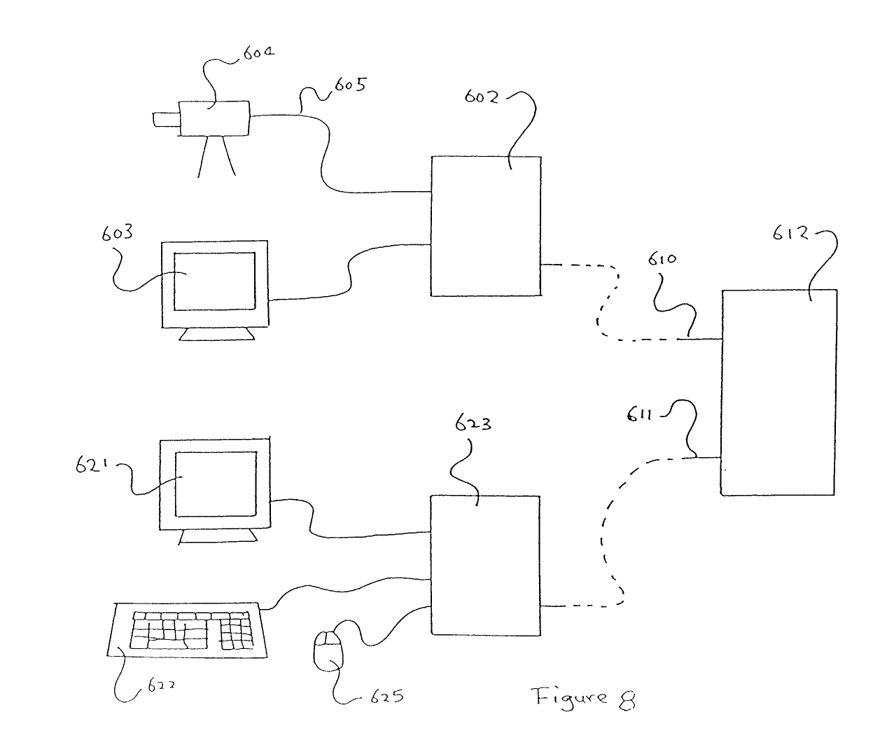

FIG. 7 illustrates how a personalized garment coordination effect is displayed on a displaying screen. The facial image 701 is a real life facial image of the user. The body image beneath the facial image is a body model faithfully structured according to the body profile data of the user. The facial and body images are constructed to be in proportion to real life dimensions. The left half of the clothing image represents and M (medium) size slightly shorter than the requirement. The right half of the clothing image represents and L (large) size garment slightly larger than the appropriate dimension. In the garment coordination process, different garments of appropriate sizes are displayed for the user to select the style she like best, without actually putting the garment on. The purpose of FIG. 7 is to demonstrate how different simplified standard size garments can be virtually tried on the displaying screen. Suppose the body size of the user is between M and L sizes. The left hand side image represents the coordinated view when a M size clothing is put on the virtual body of the user. The right hand side image represents the view of a L size garment. It can be observed that a L size garment, although slightly oversized fits better than the M size garment. When the BP coded sizes of the user and the BP code representing the garments are available, the user can accurately try different standard sizes of the garment without actually putting them on the user's body. The system is particularly important for internet based garment retail because the users do not have an opportunity to try the garment before it is ordered and mailed.

FIG. 8 illustrates a setup of internet garment shopping making use of the system invented. In accordance with the existing invention, firstly the user is required to provide measurements of his/her body profile into the computer. The computer will generate a BP code representing his/her body profile. This BP code is also useful when the user conducts virtual garment shopping in a brick and mortar garment retail store supporting the BP coding system. If the facial image of the user had not been previously stored in the system, the user may make use of his/her digital camera 604 at home to take a snap shot of his/her facial image. This facial image, usually in JPEG or Bitmap format, is required to be touch up to eliminate the background pictures, because most people do not have a non-interfering background and automatic imaging processing software at home. Alternatively a home computer in conjunction with a digital camera or a scanner may also be configured to perform the facial image capture function. A code comprising one or more code words representing the user is assigned to identify the electronics image file captured. The similar set up of 604, 605 and 602 can be used to generate electronics image files of an assortment of garments and store the electronics garment image data at the local computer or the remote computer 612. A code comprising one or more code words is assigned to identify one garment from another. In a mode of operation, the remote computer 612 represents the host computer of the garment retailing web site and the communication link 610 represents the internet connection. Image files of the garment are normally stored at the host computer 612. The facial image file can be stored at the home computer 602 or the host computer 612. If the facial image file is stored at the home computer 602, the life like garment coordination is only possible to be performed at the specific home computer 602 where the facial image of the user is stored. If the facial image file is stored at the host computer 612, the user can obtain the life like garment coordination service through any remote computer terminals accessible to the host computer 623.

Computer 623 is also configured to connect with the remote computer 612 through a communication channel or communication link 611. In the latter case, monitor 621 displays the matching picture of the selected facial image combined with the selected garment image. Codes representing the selected facial image and garment are entered into the computer 623 by input devices such as the keyboard 622 or the mouse 626. Usually the user may select a variety of garment images to try with the personalized facial image in order to determine which garment design offers best fitting with the personal characteristics of the user. Alternatively, users may coordinate and harmonize garment with the facial image of a friend or relative in order to select a garment gift for the particular friend and relative, without the real person to present on spot to support the selection and coordination process.

In one mode of operation, the camera and computer is set up at a point of sale and the customer takes a facial image at this spot. The customer may use the monitor 603 connected with the same computer 602, or the monitor 621, connected to the computer 623 to coordinate this facial image with different garment image stored in any of the computers 602, 612 and 623.

In another mode of operation disclosed in the parent application, the monitor 621 represents the facial displaying monitor 501 of FIG. 1. In this case, the regional computer 507 is identical to the computer 623. When the customer feels interest about the garment 506, he/she just key in the code represents his/her facial image. The image will be shown on the monitor and the customer is ready to appraise how he/she will look with the garment 506 without actually putting the garment on.

It should be noted that the communication channels 610 and 611 can be any type of channels connecting two computers together, as defined in this specification, or any other way to connect between two computers not mentioned in the specification, no matter if the computers are connected by wired, optical or radio frequency communication links. It should be noted that the image capturing computer 602 and the image reading computer 623 may in fact be the same single computer to carry out the preferred function of the subject invention. In this situation the communication channels 610, 611 become the same single communication channel.

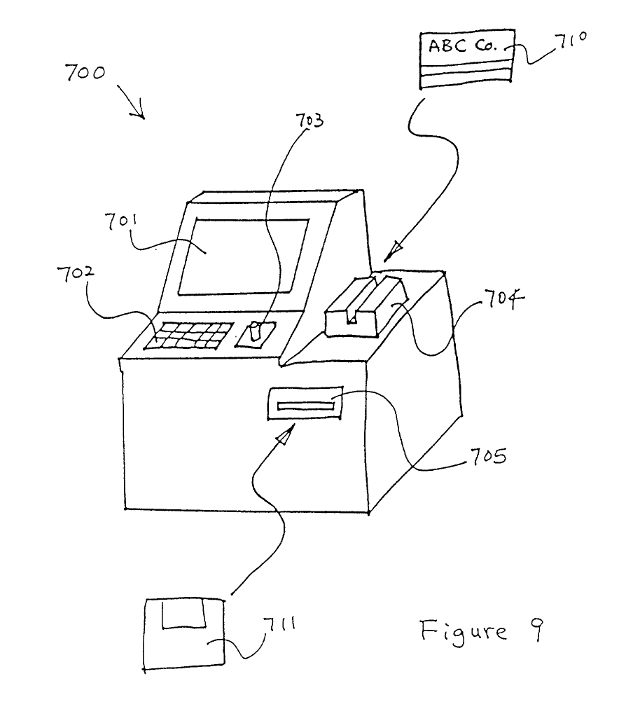

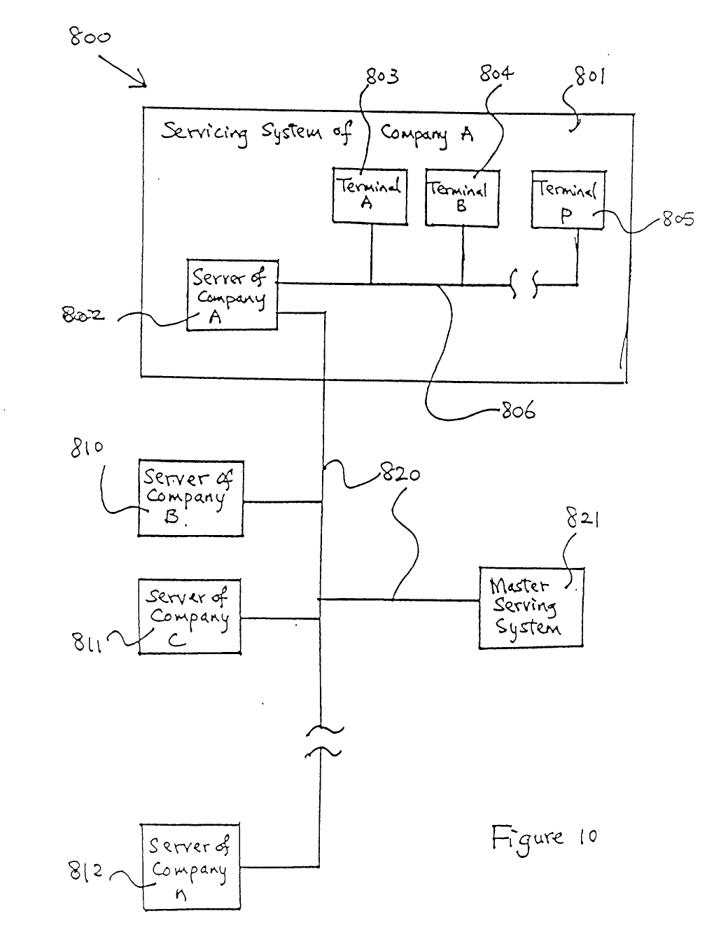

FIG. 9 discloses an embodiment of the servicing station to be set up at a point of sale in accordance to the disclosure of the invention. The terminal 700 comprises a screen 701 and control input devices are represented by a keyboard 702 and a joystick 703. Further data input device are represented by the card reader 704 and disk drive 705. It should be noted that the control and data input device illustrated are exemplary and other alternative input devices such as touch screen, touch pad, voice control devices or mouse can be used. A user may carry a tag, or card containing a BP code during the shopping time. In many applications, this card can be a combination of the BP coding card and also the credit card issued by the store or a third party such that the user can use one card to complete the shopping process. When the BP code is read by the card reader 704, a virtual body in proportion to the body dimensions decoded from the BP code is displayed on the screen. An arbitrary face image may be used to combine with that virtual body image to try the selected garment images selected by the user. If the card 710 contains a user reference code, which corresponds to a data file representing the face image of the user, the terminal will fetch the face image from the face data storage device. Usually this storage device is located at a central server, which services multiple terminals, like the one illustrated in FIG. 9. In case users do not want their facial images to be stored in a server or computer of a store for privacy or security reasons, they can prepare their facial image file on a portable diskette 711. Their facial images are retrieved every time when the diskette 711 is inserted into the disk drive mechanism 705. When a diskette of sufficient memory capacity is used, multiple facial images of different people, or for the same person with different hair styles can be stored on the same diskette 711. The multiple facial images feature on a single diskette is very important because a mother can go shopping for the whole family while the kids are at school and the husband is working in the office. Alternatively a husband can take the reference ID number, BP code or ID card 710 of his wife to shop a garment as her birthday gift, without the presence of the lady at the store. The memory size of the portable media depends on the amount of information required to be stored on the media. Simple bar code or magnetic stripe is adequate to store one or more BP codes. When one or more facial image of the users are to be stored on the portable media, an optical or magnetic diskette is required.

It is a waste of the storage resources if the facial image of a user is to be stored separately in the local server system of every stores. Therefore it is highly desirable for the users to post their facial images at a central location to be shared by the server and terminals of different stores. FIG. 10 illustrates a system setup to serve this application embodiment. A user may create a personalized facial image and fed the data file representing this facial image through the terminal 803 of a selected store for storing at a centralized storage area located at a master servicing system 821. Whenever the user logs in at the terminal of another store C, the server 811 of the store request the facial image of the user from the master servicing system 821. When the facial image is fetched, it is sent to the terminal and the facial image is reconstructed for garment coordination service of the user. Every time when a user updates a facial image, this image is then posted at the centralized master servicing system 821. It should be noted that two different kinds of networking system is being used in this application example. The connection 820 represents a network external to the servicing company such as the internet or any other global network capable to provide the similar function. The second network 806 is typically internal to the company. This network connects all the servicing terminals 803 to 805 to the server 802 of the company. Each of the terminal can be represented by the embodiment 700 illustrated in FIG. 9.

FIG. 10 can be interpreted differently to provide another efficient embodiment for the system. When a sharing data such as facial image is firstly submitted to the system, it is stored at the storage area of the receiving server, say server C. Server C then communicates the code number of this sharing data to the master servicing system indicating that the sharing data is stored at it's system. When the user visits another company A and logs in the same user number at a terminal, the server of company A will look at the directory and contact server C to fetch the sharing data through the communication network 820. The benefits of this alternate system is that if the sharing data is located at a place the user accesses frequently, the contact terminal can fetch the sharing data through it's internal network system 806 which is quicker and cheaper than to collect the data through the internet and the internal system of the master servicing system. In case company A detects that the user is also a frequent customer, it may decide to simultaneously store the sharing data of the user in it's storage area. In this situation, the server of company A will report to the master servicing system that it is keeping another copy of the sharing data. This procedure is necessary because the user may update the sharing data from time to time. Whenever sharing data is updated, the master servicing system will fetch the updated data and distributes it to the servicing system of all the participating system claiming that the sharing data had been stored. Under many situations in this business model, it is desirable to set up a central data management company linking up with the retail stores, through internet or other communication channels. The data management company receives the notification when a user log in at a particular store and then direct the computer system of the store to fetch the related BP or facial information from another location storing the required information. Every time the storage location of the related BP or facial information is updated or changed, the directory record of this servicing company is updated. Alternatively, this servicing company may keep all BP or facial information for a group of customers, and provide the data update management and data storage to all selected retail stores. The servicing company may receive a very small charge from the store every time when information is requested. Alternately, a higher fee may be charged when a transaction supported by the service is recorded.

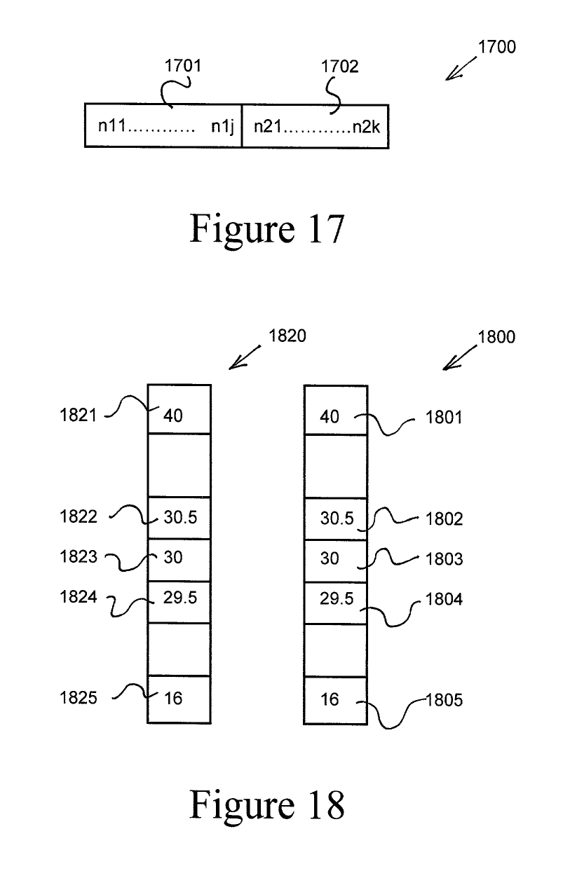

Attention is now drawn to FIG. 17 which illustrates the structure of a compound BP code 1700 having a primary code 1701 described by the digits n1 to n1j; and a supplemental code 1702 represented by the digits n21 to n2k. Listed below are many other exemplary embodiments of this supplemental code:

(1) using the supplemental code to define the size chart to be used for fitting reference;

(2) using the supplemental code to increase the incremental resolution of a parameter for higher precision garment fitting or ordering;

(3) using the supplemental code to define additional parameter normally not specified in the primary code, such as the head dimension of a person for selecting a hat;

(4) using the supplemental code to define non dimensional related information desired to be attached to the code; such as material or color information to supplement the BP code of a garment;

(5) using the supplemental code to extend the range of a parameter described in the primary code, so as to enable the dimension of odd size person to be represented;

(6) using the supplemental code to define the linearity of the quantization scheme of a parameter;

(7) using the supplemental code to define a characteristic of the primary or the supplemental codes;

(8) using the supplemental code to define a style oriented offset value;

(9) using the supplemental code to represent the relationship of two parameters; such as defining the relative off set value in between two proportional parameters;

(10) using the supplemental code to define the geographical origin of a BP code; this information enables a proper size chart to be selected for fitting purpose.

Attention is now drawn to FIG. 18 which illustrates the relationship of two different parameters represented by a BP code. The variable parameter 1820 represents the sleeve measurements of a BP code system. This parameter comprises of 49 discrete values with a range measured from 16 inches to 40 inches, and with a quantization level of 0.5 inch. The variable 1800 represents the inseam measurement of the system. Assuming this parameter also comprises of 49 different values, also measured from 16 inches to 40 inches, and increments by 0.5 inch for each value; the total combination of these two parameters alone are 49×49=2401 combinations. If it is assumed that an average person having an inseam of n inches, the sleeve of said person should be within the range of n inches plus/minus 5 inches, the number of variables of the sleeve will be reduced from 49 to 11. The combinations of these two parameters is then reduced to 49×11=539 possible combinations. Under this modified compression scheme, the representation of the sleeve measurement is obtained by calculating the value offset from the corresponding inseam measurement. For example, it is assumed that a person having an inseam of 30 inches as represented by the element 1803, the sleeve of this person is represented by a predefined corresponding value of the sleeve scale, say also 30 inches as represented by the element 1823, plus or minus a measured offset value. If the offset value is one unit, the sleeve of the person is 30.5 inches as represented by the value 1822. If the offset value is minus one units, the sleeve measurement is 29.5 inch as represented by the value 1804. It should be noted that offset can be represented by a group of signed number, or by a group of unsigned number representing the same range.

FIG. 19 illustrates another application of the offset concept developed during the research of the BP code. The size chart 1900 comprises of 6 different sizes ranged from XS to XXL. This size chart is a very common size chart utilized by many garment retailers. The problem of this size chart system is that the medium size in one country may not be the same size as in another country. The physical measurements of an inner garment of a particular size, say medium size, is usually very different as compared with the measurements of an overcoat, of the similarly specified medium size; although these garments may be designed and produced by the same manufacturer. In addition, different clothing styles also define different garment fitting requirements. All these variations prohibited the use of an universal size chart defined by absolute garment measurements. BP code is a universal system represents the exact measurements of a human body or a garment. In order for this rigid measurement system to fit with the different existing size charts used in the stores, it is desirable to use a supplemental code to define the particular size chart to be fitted. Alternately a standard size chart can be used for fitting and an offset value is included to define particular desired variation of fitting criteria. For an example as illustrated in FIG. 19, a fitting program determines that the body profile of a consumer matches with the middle size of an inner garment made by a manufacturer. It is obvious that the outer garment such as an overcoat of the same manufacturer having exactly the same dimensions of the middle size inner garment will not be able to fit the body size of the same consumer. Accordingly, an offset from middle size to large size of the standard size chart as illustrated by the action 1901 is required to accompany the BP code of the outer garment to fit the target users.

FIG. 20 illustrates a modified offset concept wherein one or more parameters of the garment measurements are offset to fit the user. For example, the scale 2300 illustrates the neck circumference measure of a dress, the scale 2200 represents the chest circumference of the dress and the scale 2000 represents the sleeve measurements of the same dress. It is the desire of the designer to have a sleeve shorted than a standard shirt. Accordingly, the neck and chest scales are handled as a regular shirt but the sleeve measurement is defined by an offset value rerpesented by the scale 2100. The offset of a particular measured parameter is particularly useful for fitting designer clothing that requires modified fitting criteria.

From the foregoing, it should now be appreciated that applicant has disclosed herein embodiments of a complete system suitable for users to perform virtual garment coordination, with a real life looking facial image to view and select garments. The described BP coding system is suitable for users and garment manufacturers to describe their garment related dimensional characteristics by one or more universal multiple digits code. The system enables relatives or friends to appraise and purchase gift clothing without the presence of the user. It is recognized that the system also enables simplified standard garments to be virtually tried before an order is placed, during an internet shopping. Alternatively discrepancy between a BP code data file and the closest standard size garment can be analyzed before the garment is tried. It is contemplated that two different garments, each combined with the facial image of the user, can be displayed side by side for comparison purpose. Alternatively, two garments of the same design but of different standard sizes can be displayed side by side, in part or in whole for the user to determine which standard size provides the most compromised fitting. The system is also applicable for a fashion designer to provide computer supported custom fashion design service to fit the special body profile of a customer. The BP data decoded is also suitable for linking with the computer aided manufacturing facility to automate and optimize the cutting of fabric patterns. Alternatively, the BP code collected at different times can be used for a computer to analyze if the changing of the body profile is normal according to a base of reference data previously established. Although detailed embodiments of the invention have been disclosed, it is recognized that variations and modifications, all within the spirit of the invention, will occur to those skilled in the art. It is accordingly intended that all such variations and modifications be encompassed by the appended claims.

I claim:

1. A method of processing a body profile (BP) code describing the physical dimensions of a human body to facilitate garment shopping, said method comprising:
defining m different physical dimensional parameters of a body;
measuring for each of said m defined parameters a physical dimension of said body to produce m quantized digital values;
processing said m quantized values to produce said BP code comprising a compressed multidigit code representing said m quantized digital values;
defining n available sizes of a garment by a size chart;
processing said BP code to determine one of the n sizes of said garment to be a recommended size for fitting said human body.

2. The method of claim 1 wherein said size chart is a pre-existing size chart being utilized prior to the introduction of said BP Code system, said method further comprising a step to define the fitting criteria of each garment size for matching with a BP code received.

3. A method of producing a body profile (BP) code to describe the physical dimensions of a human and/or garment body, said method comprising:
defining m different physical dimensional parameters of a body;
measuring for each of said m defined parameters a physical dimension of said body to produce m quantized digital values;
defining the relative relationship between the values of a first physical dimensional parameter and a second physical dimensional parameter; and
processing said m quantized values and said relative relation to produce said BP code comprising a compressed multidigit code representing said m quantized digital values.

4. The method of claim 3 wherein said relative relationship defines an offset indicator of said second physical dimensional parameter relative the measured value of said first physical dimensional parameter and said BP code comprises of information representing said offset value.

5. The method of claim 3 further comprising a step to define the relationship of said physical dimensional parameters with a size chart of another human body and/or garment style.

6. A method of producing a body profile (BP) code to describe the physical dimensions of a human and/or garment body, said method comprising:
defining m different physical dimensional parameters of a body;
measuring for each of said m defined parameters a physical dimension of said body to produce m quantized digital values; and
processing said m quantized values to produce said BP code comprising a primary compressed n1 digits code and a supplemental n2 digits code for representing said m quantized digital values.

7. The method of claim 6 wherein said n2 digits code defines a size chart for fitting purpose.

8. The method of claim 6 wherein said n2 digits code comprises of information to enhance resolution of said n1 code.

9. The method of claim 6 wherein said n2 digits code comprises of information about at least one physical dimensional parameter not represented by said n1 code.

10. The method of claim 6 wherein said n2 digits code comprises of non-dimensional related information about said human and/or garment body.

11. The method of claim 6 wherein said n2 digits code comprises the out of range information of a parameter represented by said n1 digits code.

12. The method of claim 6 wherein said n2 digits defines the quantization linearity of at least one of said parameters.

13. The method of claim 6 wherein said n2 digits code further comprises a n3 digits code for defining the nature or relationship of said n1 and/or n2 digits code.

14. The method of claim 13 wherein said n2 digits code defines an offset value to be processed with said size chart.

15. The method of claim 6 wherein said n2 digits code defines the relationship between two physical dimensional parameters represented by said n1 digit code.

16. The method of claim 6 wherein said n2 digit code defines the geographical origin of said BP code.

17. The method of claim 6 wherein said n1 digits code is a functional code independent on said n2 digits code.

18. The method of claim 6 wherein said n1 digits code comprises a code to inform the decoding process that a supplemental n2 digit code is to follow.

19. A method of producing a body profile (BP) code to describe the physical dimensions of a human and/or garment body, said method comprising:
defining m different physical dimensional parameters of a body;
measuring for each of said m defined parameters a physical dimension of said body to produce m quantized digital values; and
processing said m quantized values to produce said BP code comprising a compressed multidigit code representing said m quantized digital values; wherein at least one of said m defined parameters comprises non-linear quantized values.

20. The method of claim 19 wherein said non-linear quantized values defines the fitting of a size chart.

21. A business method to facilitate garment purchasing making use of a body profile (BP) code to describe the physical dimensions of a human body, said method comprising:
defining m different physical dimensional parameters of said body;
measuring for each of said m defined parameters a physical dimension of said body to produce m quantized digital values;
processing said m quantized values to produce said BP code comprising a compressed multidigit code representing said m quantized digital values; and
storing said BP code at a memory location accessible by a communication link.

22. The method of claim 21 further comprising a step to provide a password allowing a person to retrieve said BP Code.

23. The method of claim 21 further comprising:
Providing a computing apparatus to convert said BP code into a specific size of a size chart.

24. A business method to facilitate garment purchasing making use of a body profile (BP) code to describe the physical dimensions of a first person, said method comprising:
defining m different physical dimensional parameters of said person;
measuring for each of said m defined parameters a physical dimension of said first person to produce m quantized digital values;
processing said m quantized values to produce said BP code comprising a compressed multidigit code representing said m quantized digital values;
enabling a second person to obtain said BP Code; and
a step for said second person to present said BP code to a seller for purchasing a selected garment for said first person.

25. The business method of claim 24 further comprising a step for the seller to fit said BP code with a size chart of a selected garment.

26. The business method of claim 24 further comprising a step for said purchased garment to be shipped by said seller directly to said first person.

27. The business method of claim 24 wherein said second person obtained the BP Code of said first person through a communication link, a network, a phone call, a letter, a fax or a written note.

28. A business method to facilitate garment purchasing making use of a body profile (BP) code to describe the physical dimensions of a person, said method comprising:
defining m different physical dimensional parameters of said person;
setting up facility in a store for measuring the physical dimensional parameters of a person;
in said store, measuring for each of said m defined parameters a physical dimension of said person to produce m quantized digital values;
processing said m quantized values to produce said BP code comprising a compressed multidigit code representing said m quantized digital values; and
produce a record storing the BP code of said person.

29. The business method of claim 28 further comprising a step to translate said BP code into a fitted size according to a size chart provided by said store.

30. The business method of claim 28 wherein said record is represented by a portable media or a digital memory location.

31. The business method of claim 28 wherein said BP code is make available to a second person enabling said second person to purchase fitted size garment for said first person.

32. A computing method for matching the body size of a person with the garment of a particular garment style comprising the steps of:
(1) providing a garment matching computing apparatus;
(2) defining m different physical dimensional parameters of said person;
(3) measuring for each of said m defined parameters a physical dimension of said person to produce m quantized digital values;
(4) defining n different physical dimensional parameters for a garment sizing standard;
(5) defining the standard fitting criteria of said garment sizing standard to fit the physical dimensional parameters of a person;
(6) defining at least one style dependent offset value from said identified standard fitted size enabling the fitting of said particular garment style with said person;
(7) storing said style dependent offset value for the processing of said computing apparatus;
(8) processing the information of steps (2) to (7) by said computing apparatus to identify the closest fitted standard size of a garment for said person; and
(9) processing said offset value to recommend a final fitted size of said particular garment style for said person.

33. The computing method of claim 32 wherein said garment sizing standard is defined by a size chart.

34. The computing method of claim 33 further comprising a step to provide a supplemental code to identify a size chart selected from a groups of different size charts.

35. The computing method of claim 32 wherein steps (2) and (3) are represented by a BP Code.

36. The computing method of claim 35 further comprising a step to decode said BP Code.

37. The computing method of claim 33 wherein said garment sizing standard comprises of j different sizes and said offset values define an intentional larger or smaller selected size for said garment style to fit a person.

38. The computing method of claim 32 wherein said offset value defines the offset of one of said n different physical measurements required for said particular garment style to fit a person.

39. The computing method of claim 32 wherein all the steps (4) to (6) are predefined precomputer activities.
